(19) United States
(12) Patent Application Publication
(10) Pub. No.: US 2018/0144073 A1
(43) Pub. Date: May 24, 2018

(54) Modeling Deformation Due To Surface Oxidation In Integrated Circuits

(71) Applicant: Synopsys, Inc., Mountain View, CA (US)

(72) Inventors: Xiaopeng Xu, Cupertino, CA (US); Aditya Pradeep Karmarkar, Hyderabad (IN); Karim El Sayed, Santa Clara, CA (US)

(73) Assignee: Synopsys, Inc., Mountain View, CA (US)

(21) Appl. No.: 15/679,082

(22) Filed: Aug. 16, 2017

Related U.S. Application Data
(60) Provisional application No. 62/426,071, filed on Nov. 23, 2016.

(51) Int. Cl. G06F 17/50

(52) U.S. Cl. CPC G06F 17/5009; G06F 2217/12

(57) ABSTRACT

Oxidation of high aspect ratio IC structures, such as pillars and fins, can deform them. Disclosed is technology for simulating the deformation efficiently so that process conditions or pattern design can be altered to improve manufacturability. A database describing a 3D model of the structures prior to the oxidation process is provided. Oxidation is simulated in 1D on different surfaces to estimate a depth of starting material that will be converted during oxidation. Starting material is then replaced to that depth on all surfaces, by oxide with known expansion ratio. An initial mechanical stress and strain field is determined based on the model in dependence upon the replacement depth and the expansion ratio, and the system relaxes the fields to their equilibrium states, which include the deformations. The deformations are reported to a user, who can repeat the process using different oxidizing conditions and/or patterns to optimize manufacturability.

### CROSS REFERENCE TO RELATED APPLICATION

This application claims priority under 35 U.S.C. § 119(e) to U.S. Provisional Application No. 62/426,071, entitled “METHOD FOR ANALYZING MACRO-SCALE SILICON PILLAR BENDING DUE TO OXIDATION STRESS,” filed on Nov. 23, 2016, by Xiaopeng Xu, Aditya Pradeep Karmarkar and Karim El Sayed, the entire contents of which are hereby incorporated by reference herein.

### FIELD OF THE TECHNOLOGY DISCLOSED

This invention relates to the modeling of integrated circuit devices and more particularly to the modeling of integrated circuit devices in computer aided design (CAD) and electronic design automation (EDA) systems.

### BACKGROUND

An integrated circuit (IC) integrates a large number of semiconducting devices into a small chip. Advances in IC technology have led to non-planar or three-dimensional transistors and memory devices that allow greater densities of devices and circuits in IC chips and enhanced performance.

Advanced three-dimensional transistors and memory devices feature components with high aspect ratio. As used herein, the aspect ratio of a structure is the ratio of the height of the structure in the vertical dimension to the average width of the structure in its smallest lateral dimension. Aspects of the invention are most useful for structures having an aspect ratio of at least 2:1, though they can provide advantages for smaller aspect ratio structures as well. Examples of high aspect ratio structures that are present in integrated chips are narrow, thin fins that form the source, drain, and channel of FinFET transistors, and vertical pillars or channels that connect stacked horizontal layers of memory cells in three-dimensional NAND flash memory. These high aspect ratio structures are mechanically weak. If a material different than the one present on the structures' surface is deposited on these high aspect ratio structures, they are susceptible to bending and cracking due to intrinsic stress from the deposited films. For example, if high aspect ratio structures undergo an oxidation process to passivate their surfaces by the formation of oxides, they may deform during the process, which in turn may affect the performance of the integrated chips.

The fabrication of an IC chip involves a lengthy and detailed series of exacting process steps, including such steps as lithography, doping, etching, chemical mechanical polishing, oxidation, and the like. Manufacturers are constantly updating their processes, or developing new ones, and it is rarely obvious how a small change in the recipe will affect the performance of integrated circuits made using the new recipe. Usually, test structures are fabricated using the new process, and these structures are evaluated by observing their features and performance. Process engineers then revise the recipe further and try again. But fabrication can be costly and time-consuming, and thus cannot be performed as often during process development as would be desired. Simulation can perform some aspects of the evaluation with the help of computer aided design (CAD) and electronic design automation (EDA) systems. However, many needed aspects of the evaluation still require physical fabrication of test structures.

Significant fin deformation and cracking due to surface oxidation in FinFETs can cause device failure. The stress from the deposited film can also significantly change the mobility of carriers in the fin. In three-dimensional NAND flash memory, deformation in the vertical pillars in one horizontal layer of memory cells can cause misalignment and other issues while fabricating the layer on top. It would be highly desirable to be able to analyze deformations in high aspect ratio structures due to surface oxidation by CAD and EDA systems early in the development of the fabrication process, so that an oxidation mechanism and a set of oxidation process parameters (temperature, pressure, oxidants, etc.) can be identified that minimizes deformation in high aspect ratio structures.

### SUMMARY

The summary below is provided in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description that is presented later. Particular aspects of the invention are described in the claims, specification, and drawings.

A system and a method are provided that can be used for analyzing deformation in high aspect ratio structure in integrated chips early in the development of a fabrication procedure that includes a new or modified oxidation process. Existing tools which would be used to perform such analysis are highly inadequate. For example, process simulation tools, which could be used to simulate surface oxidization and deformation, are designed for analyzing very small structures, such as one or a few transistors. They usually require a huge amount of computation time to simulate the processes on the scale of a full chip or even part of a chip. As another example. Simulations of process steps that involve boundary movement, such as oxidation steps, are notoriously difficult and time-consuming, and often fail. In order to overcome the problems, roughly described, a three-dimensional model is provided for an integrated circuit in its state prior to the oxidation step to be analyzed, wherein the integrated circuit includes one or more high aspect ratio structures with surfaces consisting of a surface material. The system identifies, from the three-dimensional model, the locations of all the surfaces that are prone to oxidization during the oxidation process. The system performs a one-dimensional oxidation simulation for each of the identified surfaces to estimate a first depth of surface material that will be oxidized to form an oxide film during the oxidation process for a set of oxidation process parameters under test. The oxide film grows orthogonally to the oxidizing surface, so the one-dimensional oxidation simulation is orthogonal to such surface. The system then replaces the surface material at each of the plurality of identified surfaced in the three-dimensional model with the oxide material to the first depth estimated by the one-dimensional oxidation simulation. An initial mechanical stress and strain fields are determined in the three-dimensional model in dependence upon the first depth of oxide material and a predetermined volumetric expansion ratio of the oxide during the oxidation process. An equilibrium mechanical stress and strain fields are then determined in dependence upon the initial mechanical stress and strain field. The system deforms the high aspect ratio structures in the three-dimensional model based on the equilibrium mechanical strain field. The system then reports the deformations in the three-dimensional model to one or more users. The system further includes the capability of repeating the estimating the first depth of surface material that will be oxidized, replacing the first depth of surface material with an oxide material, determining an equilibrium stress and strain field, and deforming high aspect ratio structures based on the equilibrium strain field using a revised set of oxidation process parameters to improve manufacturability of the integrated circuit device.

Embodiments of the invention or elements thereof can be implemented in the form of a computer product including a computer readable storage medium with computer usable program code for performing the method steps indicated. Furthermore, embodiments of the invention or elements thereof can be implemented in the form of an apparatus including a memory and at least one processor that is coupled to the memory and operative to perform exemplary method steps. Yet further, in another aspect, embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

These and other features, aspects and advantages of the invention will become apparent from the following detailed description of illustrative embodiments thereof, which is to be read in connection with the accompanying drawings.

### BRIEF DESCRIPTION OF THE DRAWINGS

The invention will be described with respect to specific embodiments thereof, and reference will be made to the drawings, in which:

FIG. 1 (including FIGS. 1A and 1B collectively) illustrates a one-dimensional oxidation simulation.

FIG. 2 (including FIGS. 2A and 2B collectively) is a cross sectional view of an array of Silicon pillars deformed during a surface oxidation process.

FIG. 3 illustrates EDA tools and process flow for integrated circuit design and manufacturing.

FIG. 4 illustrates the process flow and system to analyze deformation in integrated circuit design due to surface oxidation.

FIG. 5 (including FIGS. 5A, 5B, 5C and 5D collectively) illustrates a three-dimensional model useful for explaining the process flow and system to analyze deformation in integrated circuit design due to surface oxidation.

FIG. 6 (including FIGS. 6A, 6B, 6C and 6D collectively) illustrates a three-dimensional model after selective surface material etching by the surface material etcher in FIG. 4.

FIG. 7 (including FIGS. 7A, 7B, 7C and 7D collectively) illustrates a three-dimensional model after selective oxide deposition by the oxide material depositor in FIG. 4.

FIG. 8 (including FIGS. 8A, 8B, 8C and 8D collectively) illustrates a three-dimensional model with deformation predicted by the deformation analyzer in FIG. 4.

FIG. 9 is a simplified block diagram of a computer system.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Surface oxidation is a process by which the atoms on an exposed surface, composed of either a metal or a semiconductor, combine with the oxygen atoms and ions in its surrounding environment to form an oxide film orthogonally to the exposed surface. Although oxidation of many materials plays a role in IC technology, as silicon is the most dominant material used in IC fabrication, the main oxidation reaction during the oxidation process discussed herein is the conversion of parts of a silicon structure surface into amorphous silicon oxide (SiOₓ, with 1≤x≤2). Other starting surface materials that can benefit from the technology herein include silicon alloys (such as SiₓGe₁₋ₓ) and polysilicon. The oxidation process can be used to electrically insulate different metallic or semiconducting elements in an IC chip, and to passivate the surface to avoid corrosion by the environment in the future. As used herein, the term “surface material” of an IC structure is any material, metallic or semiconducting, that is present on the surface of the structure and on which the subject oxidation process will occur. In one embodiment, the IC structure may be fabricated entirely of the surface material. In another embodiment, the IC structure may have one one or more materials below the surface material, and in yet another embodiment, the IC structure may have a thin initial layer of oxide already formed on the surface material.

Usually, a high-temperature environment drives the chemical reaction between oxygen and surface material to generate an oxide on the surface of an IC structure; however, even at room temperature, a shallow film of oxide can form. In order to grow thicker oxides in a controlled environment, several oxidation methods can be used, for example: (a) dry thermal oxidation at high temperatures (800° C.-1200° C.) using pure molecular oxygen (O₂) as the main oxidant; (b) wet thermal oxidation at high temperatures (800° C.-1200° C.) using water vapor or steam (H₂O) as the main oxidant; and (c) radical oxidation at a lower process temperature (150° C.-400° C.), using oxygen ions (O⁻, O₂⁻, O₂²⁻) as the main oxidants.

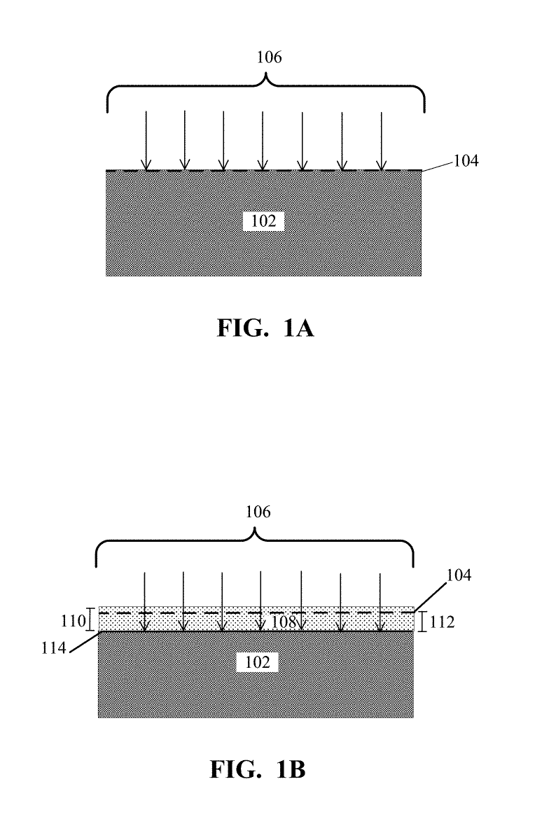

FIG. 1A illustrates a cross-sectional view of a slab 102 at the beginning of the oxidation process. The slab's top surface 104, composed of a surface material, is exposed to an environment of oxidants 106. The oxidants travel to the slab surface 104 to chemically react with the surface material atoms on top of the slab surface 104 to form an oxide film. FIG. 1B illustrates a cross-sectional view of the slab 102 in FIG. 1A during the oxidation process. An oxide film 108 has formed on top of the slab 102. The oxidants 106 diffuse through the top oxide film 108 to the surface material-oxide interface 114, and react with the atoms at the interface. Because the oxidants diffuse, they are sometimes referred to herein as diffusants. At the start of the oxidation process, the slab's surface was at level 104. During the oxidation process, the surface material has dropped to level 114. Therefore, a first depth of surface material 112 has been oxidized to form a second depth 110 of oxide layer. The second depth of oxide thickness 110 can be greater than the first depth of surface material oxidized 112 if the oxide has a lower density than the surface material. In another embodiment, the oxide may have a higher density than the surface material; thereby, the second depth of oxide thickness can be less than the first depth of surface material oxidized. The surface being oxidized in FIG. 1 is lateral (parallel to the substrate major surface), but in other embodiments vertical surfaces and surfaces that can be rounded are also oxidized. As used herein, the “depth” of oxidation refers to the depth in a direction perpendicular to the surface of interest. Thus the depth could be in a vertical direction, horizontal direction, or something in between.

The set of oxidizing conditions that determine the first depth of surface material that will be oxidized during the oxidation process includes one or more of the following: (a) temperature, (b) atmospheric pressure, (c) oxidant (e.g. O₂, H₂O, O⁻, O₂⁻, O₂²⁻), (d) availability of oxidants, (e) thickness of any oxide layer already present on the structure surface, and (f) time duration of the oxidation process. As used herein, the orientation of the surface relative to crystalline facets is not considered to constitute an “oxidizing condition”. Note that in an embodiment, the set of oxidizing conditions can include a plurality of subsets of oxidizing conditions applicable at different times in the oxidation process.

The surface orientation dictates the densities of atoms available for oxidization for that given surface. A larger number of bondable Si atoms are available on the (111) Si surface when compared to the number of bondable Si atoms available on the (100) Si surface. Therefore, oxide growth appears to be faster on (111) oriented silicon surface when compared to (100) oriented silicon surface. Surfaces that are not oriented exactly parallel to a crystal facet will have an oxide growth rate that, to a first order of approximation, can be determined by interpolating from the growth rates of surfaces which are oriented parallel to the crystal facets.

Deformation in high aspect ratio structures can be caused by stress exerted by the deposited oxide layer on the structure's surface. The source of the stress exerted by the deposited film can stem from volume expansion or shrinkage of the oxide during the oxidation process. The density of deposited silicon oxide film is lower than that of the silicon that it replaces, In particular, the deposited oxide film occupies ˜2.2 times the volume of the surface material consumed during the oxidation process in silicon structures.

Three-dimensional FinFETs and memory devices are densely packed in an integrated circuit. The space between multiple fins in a FinFETs is kept to a minimum, and the fins are made as high as possible to get the best ratio of current flow to lateral surface area. In three-dimensional NAND flash memory, vertical pillars that connect stacked horizontal layers of memory cells are also in close proximity to neighboring pillars and other IC components. Therefore, during the oxidation process, how a high aspect ratio structure will deform will also depend on its surrounding structures. In the case of closely packed high aspect ratio pillars, two or more pillars may conjoin. In the case of FinFETs, the spacing between fins can deform to increase the variability along their length.

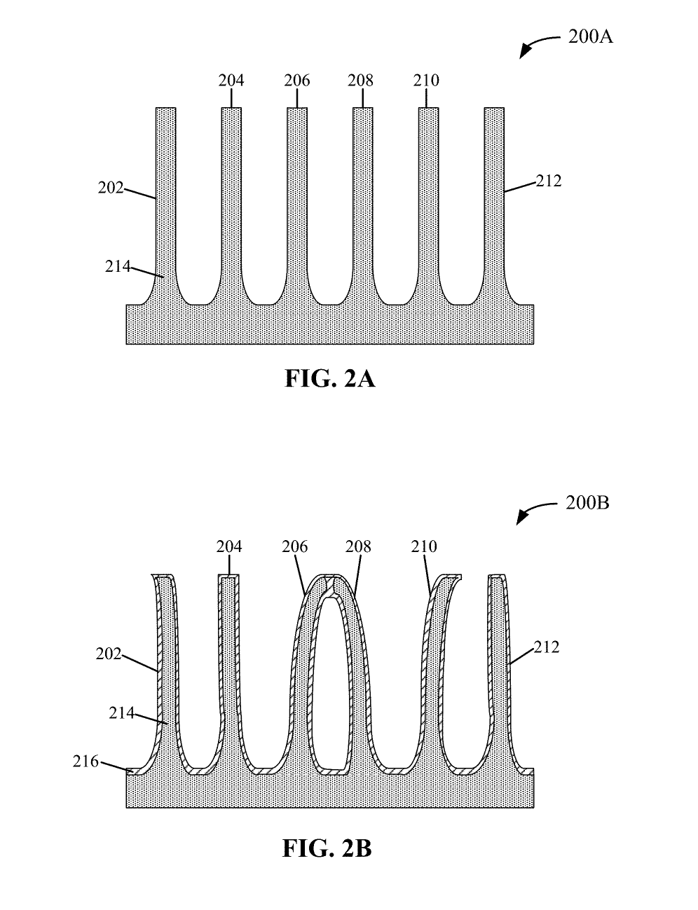

FIG. 2A is a cross sectional view 200A of an array of nanopillars 202, 204, 206, 208, 210, and 212 of surface material 214 formed on a substrate prior to an oxidation process. FIG. 2B is a cross sectional view 200B of an array of silicon pillars 202, 204, 206, 208, 210, and 212 after the oxidation process. A thin film of oxide 216 has deposited over the silicon pillars' surfaces during the oxidation process. While pillars 202, 204, 210, and 212 show slight deformations, pillars 206 and 208 have more pronounced deformations, causing the two pillars to touch. As used herein, no distinction is intended between structures which are disposed in the substrate body itself, or disposed in an overlying layer. For example, the nanopillars in FIG. 2A are described equivalently herein as being either “on” the substrate or “in” the substrate, and no distinction is intended between the two words.

### Overall Design Process Flow

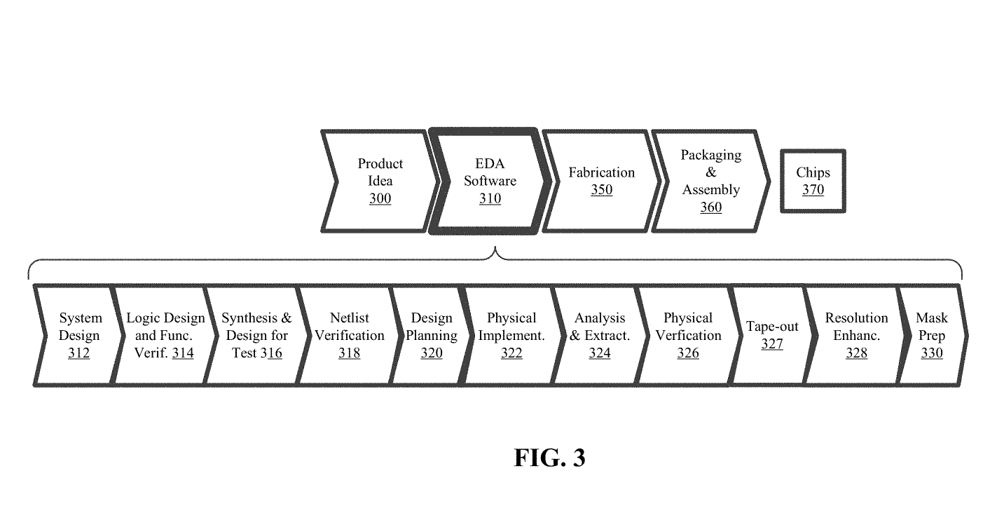

Aspects of the invention can be used to support an integrated circuit design flow. FIG. 3 shows a simplified representation of an illustrative digital integrated circuit design flow. At a high level, the process starts with the product idea (step 300) and is realized in an EDA (Electronic Design Automation) software design process (step 310). When the design is finalized, it can be taped-out (step 327). At some point after tape out, the fabrication process (step 350) and packaging and assembly processes (step 360) occur resulting, ultimately, in finished integrated circuit chips (result 370).

The EDA software design process (step 310) is itself composed of a number of steps 312-330, shown in linear fashion for simplicity. In an actual integrated circuit design process, the particular design might have to go back through steps until certain tests are passed. Similarly, in any actual design process, these steps may occur in different orders and combinations. This description is therefore provided by way of context and general explanation rather than as a specific, or recommended, design flow for a particular integrated circuit.

A brief description of the component steps of the EDA software design process (step 310) will now be provided.

System design (step 312): The designers describe the functionality that they want to implement, they can perform what-if planning to refine functionality, check costs, etc. Hardware-software architecture partitioning can occur at this stage. Example EDA software products from Synopsys, Inc. that can be used at this step include Model Architect, System Studio, and DesignWare® products.

Logic design and functional verification (step 314): At this stage, the VHDL or Verilog code for modules in the system is written and the design is checked for functional accuracy. More specifically, the design is checked to ensure that it produces correct outputs in response to particular input stimuli. Example EDA software products from Synopsys, Inc. that can be used at this step include VCS, VERA, DesignWare®, Magellan, Formality, ESP and LEDA products.

Synthesis and design for test (step 316): Here, the VHDL/Verilog is translated to a netlist. The netlist can be optimized for the target technology. Additionally, the design and implementation of tests to permit checking of the finished chip occurs. Example EDA software products from Synopsys, Inc. that can be used at this step include Design Compiler®, Physical Compiler, DFT Compiler, Power Compiler, FPGA Compiler, TetraMAX, and DesignWare® products.

Netlist verification (step 318): At this step, the netlist is checked for compliance with timing constraints and for correspondence with the VHDL/Verilog source code. Example EDA software products from Synopsys, Inc. that can be used at this step include Formality, PrimeTime, and VCS products.

Design planning (step 320): Here, an overall floor plan for the chip is constructed and analyzed for timing and top-level routing. Example EDA software products from Synopsys, Inc. that can be used at this step include Astro and Custom Designer products.

Physical implementation (step 322): The placement (positioning of circuit elements) and routing (connection of the same) occurs at this step, as can selection of library cells to perform specified logic functions. Example EDA software products from Synopsys, Inc. that can be used at this step include the Astro, IC Compiler, and Custom Designer products.

Analysis and extraction (step 324): At this step, the circuit function is verified at a transistor level, this in turn permits what-if refinement. Example EDA software products from Synopsys, Inc. that can be used at this step include AstroRail, PrimeRail, PrimeTime, and Star-RCXT products.

Physical verification (step 326): At this step various checking functions are performed to ensure correctness for: manufacturing, electrical issues, lithographic issues, and circuitry. Example EDA software products from Synopsys, Inc. that can be used at this step include the Hercules product.

Tape-out (step 327): This step provides the “tape out” data to be used (after lithographic enhancements are applied if appropriate) for production of masks for lithographic use to produce finished chips. Example EDA software products from Synopsys, Inc. that can be used at this step include the IC Compiler and Custom Designer families of products.

Resolution enhancement (step 328): This step involves geometric manipulations of the layout to improve manufacturability of the design. Example EDA software products from Synopsys, Inc. that can be used at this step include Proteus, ProteusAF, and PSMGen products.

Mask data preparation (step 330): This step provides mask-making-ready “tape-out” data for production of masks for lithographic use to produce finished chips. Example EDA software products from Synopsys, Inc. that can be used at this step include the CATS® family of products. The method for actually making the masks can use any mask making technique, either known today or developed in the future. As an example, masks can be printed using techniques set forth in U.S. Pat. Nos. 6,096,458; 6,057,063; 5,246,800; 5,472,814; and 5,702,847, all incorporated by referenced herein for their teachings of mask printing techniques.

Once the process flow is ready, it can be used for manufacturing multiple circuit designs coming from various designers in various companies. The EDA flow 312-330 will be used by such designers. A combination of the process flow and the masks made from step 330 are used to manufacture any particular circuit.

### Process Flow for Deformation Analysis

By describing one or more high aspect ratio structures in a three-dimensional mesh, the conventional modeling of oxidation and deformation requires coupling multiple, time-dependent, three-dimensional partial differential equations. Significant resources will be needed for such a complex simulation at IC scale, thereby making the approach impractical.

Techniques described herein provide a much simpler and faster simulation flow that enables technology development and design teams to evaluate various oxidation process options that start in the pre-wafer research phase to minimize deformation in high aspect ratio structures. The process flow is used to evaluate high aspect ratio structure manufacturability with respect to a new or significantly modified oxidation process and set of oxidizing conditions.

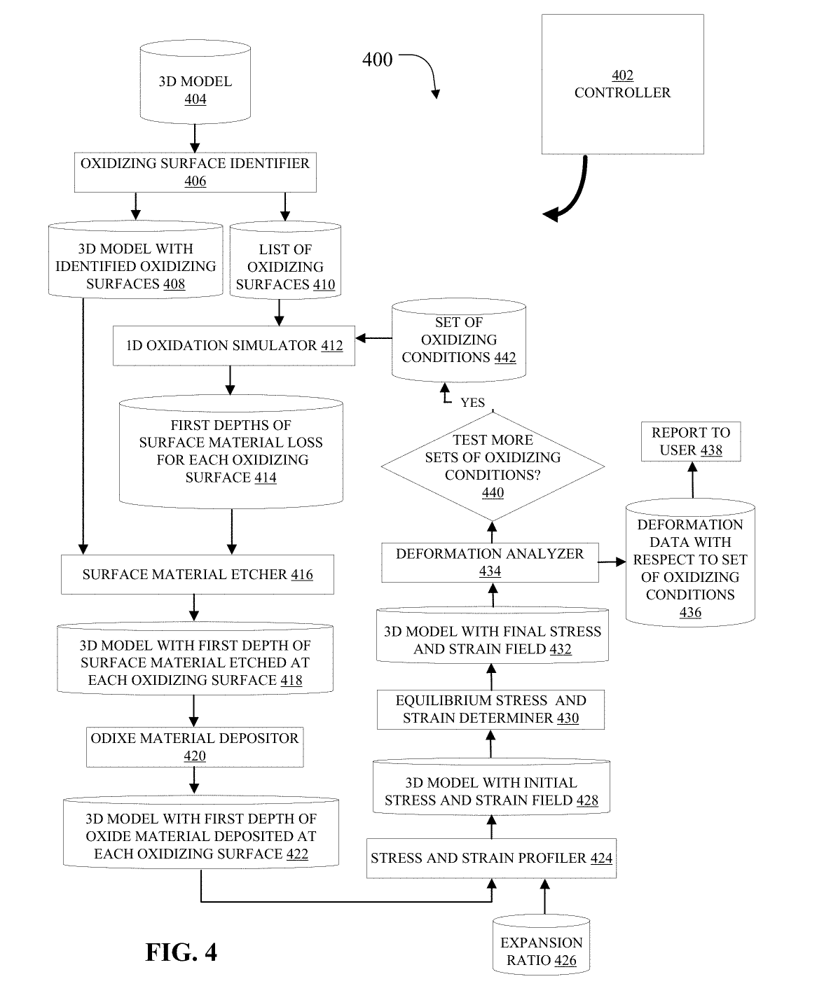

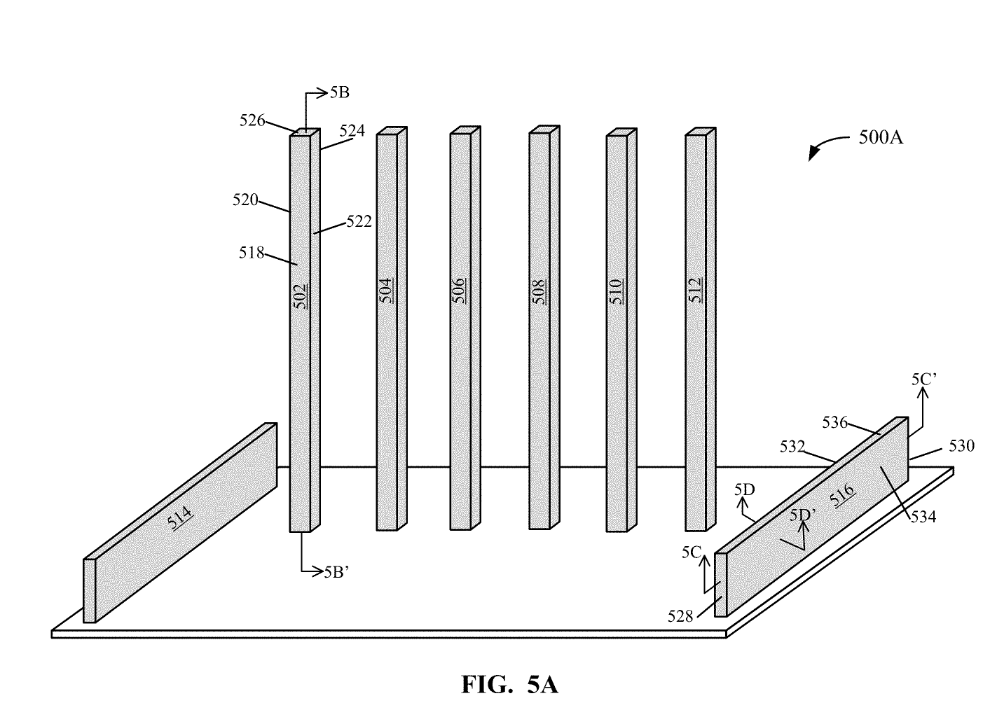

FIG. 4 illustrates an overall deformation analysis process flow 400 according to aspects of the invention. Example EDA software products from Synopsys, Inc. that can be used for the process flow 400 include Sentaurus Process and Sentaurus Interconnect.

The process flow 400 starts with a three-dimensional model in database 404 in a computer readable medium. As used herein, no distinction is intended between whether a database is disposed “on” or “in” a computer readable medium. Additionally, as used herein, the term “database” does not necessarily imply any unity of structure. For example, two or more separate databases, when considered together, still constitute a “database” as that term is used herein. Thus in FIG. 4, the database 404 can be a single combination database, or a combination of two or more separate databases. The database 404 can be stored on a hard drive or in a semiconductor memory or in one or more non-transitory computer readable media.

The three-dimensional model 404 can be provided by any means. In one embodiment it is created manually, whereas in another embodiment it is created by simulating a series of predecessor process steps. In one embodiment, the three-dimensional model 404 may represent the entire IC chip. In one embodiment, the three-dimensional model 404 may represent a part of the IC chip, such as a single memory cell. In one embodiment, all the high aspect ratio structures in the three-dimensional model 404 may have the same surface material. In another embodiment, different high aspect ratio structures in the three-dimensional model 404 may have the different surface materials.

The oxidizing surface identifier 406 receives the three-dimensional model 404 and identifies all the available, exposed surfaces that may oxidize during the oxidation process. In one embodiment the exposed surfaces may be classified by their surface materials. In one embodiment, the exposed surfaces may be classified by the orientation of the surface relative to major crystalline facets. For a crystalline silicon structure, the exposed surfaces can be classified by their orientation relative to the (100), (110) and (111) directions. For a polysilicon structure, each surface of the structure may have a plurality of crystalline surfaces. In one embodiment, the exposed surfaces may be classified both by their surface materials and surface orientations. In one embodiment, the user may assume that all the exposed surfaces have the same surface material and/or surface orientation.

The oxidizing surface identifier 406 outputs a three-dimensional model 408 with available oxidizing surfaces identified. The oxidizing surface identifier 406 also outputs a list of identified oxidizing surface 410 to a one-dimensional oxidation simulator 412.

The oxidation simulator 414 receives the list of identified oxidizing surface 410 from the oxidizing surface identifier 406. The oxidation simulator 414 also receives a set of oxidizing conditions 442. The set of oxidizing conditions 442 indicates the oxidation process conditions under which the process is to be simulated. These include, for example, temperature, oxidant supply, time duration, atmospheric pressure, etc. The one-dimensional oxidation simulator 414 determines the first depth of surface material oxidized and second depth of oxide film formed during the oxidation process as illustrated in FIG. 1B for each of the identified oxidizing surfaces in the list of oxidizing surfaces 410. This estimation is performed using an assumption that there is no physical constraint on the expansion of the oxide film during oxidation. In one implementation, the second depth of oxide produced by the oxidation process need not necessarily be noted, since it is known to be a fixed multiple, e.g. the nominal thickness of silicon oxide will be ˜1.2 times that of the first depth of silicon oxidized in a structure where silicon is the surface material. In one implementation, after the first depth of surface material that is oxidized during the oxidation process is estimated for a set of oxidizing condition and surface orientation, it can be saved in a look-up table so that it need not be performed again.

The first (and if necessary the second) depths are estimated for a plurality of surface points at which oxidation will occur. In one embodiment, this involves an oxidation simulation for every such surface point, limited only by the granularity of the mesh with which the model is represented. In another embodiment, a simplification can be employed, in which starting surfaces are idealized to be smooth. In this simplification, the oxidation simulation need be performed at only one point on each surface considered to be smooth, because the depth estimated at one surface point on the surface is applied to all surface points on the same surface. In yet another embodiment, another simplification is employed in which the oxidation simulation is performed at one point on each of only a few selected surfaces which have different orientations relative to the crystal facets. The depths estimated for these few points are then interpolated as needed to estimate the depths for starting surfaces with orientations different from those of the selected surfaces, for example at corners of the structures.

For the one-dimensional oxidation simulation, analytical and numerical modeling may be performed. In one implementation, the first depth can be estimated based on the Deal-Grove model (B. E. Deal et al., Journal of Applied Physics, 36(12):3770-3778, 1965). In one implementation, the first depth can be estimated based on the Massoud model (H. Z. Massoud et al., Journal of The Electrochemical Society, 132(11):1745-1757, 1985). Of course, other implementations through which the first depth can be estimated will be readily apparent to those skilled in the art. Both the above documents are incorporated herein by reference.

After estimating the first depths of surface material oxidized for each of the identified surfaces 414 in the list of oxidizing surfaces 410, the one-dimensional oxidation simulator directs the data to the surface material etcher 416.

The surface material etcher 416 receives the first depths of surface material oxidized for each of the identified surfaces in the list of oxidizing surfaces 414 from the one-dimensional oxidation simulator along with a three-dimensional model 408 with all the available oxidizing surface identified from the oxidizing surface identifier 406. In surface material etcher 416, surface material consumption of the first depth due to oxidation process is included in the three-dimensional model 408 for each of the identified surfaces. In some embodiments, modeling the surface material consumption due to the oxidation for the target three-dimensional structure comprises simply replacing the surface material, to the first depth, with another material such as gas or vacuum. The output from the surface material etcher 416 is a three-dimensional model with first depths of surface material etched at each oxidizing surfaces 418.

The oxide material depositor 420 receives the three-dimensional model with first depths of surface material etched at each oxidizing surface 418. Thereafter, new oxide growth due to oxidation is effected in the three-dimensional model 418. In some embodiments, modeling of the new oxide growth after the surface material consumption comprises selective oxide deposition in the region etched by the surface material etcher 416. Thereby, first depths of oxide material are deposited for each of the oxidizing surfaces in the three-dimensional model. The output is a three-dimensional model with first depths of oxide material deposited at each oxidizing surface 422. Note that in some embodiments, the surface material etcher 416 and the oxide material depositor 420 can be combined by skipping the 3D model 418 in which the etching step is effected by replacing surface material with air or vacuum. Instead, both the etching and oxide deposition steps are effected together by replacing the surface material directly with oxide material.

The stress and strain profiler 424 receives the three-dimensional model with first depths of oxide material deposited at each oxidizing surface 422 and adds mechanical stress and strain analysis to the 3-dimensional model along with the volumetric expansion ratio of the oxide 426. In some implementations, the expansion ratio is predetermined. In other implementations, the expansion ratio is calculated from the first depth of surface material consumption and the second depth of the oxide layer estimated in the one-dimensional oxidation simulator 412. Example EDA software products from Synopsys, Inc. that can be used as a stress and strain profiler 424 includes “Sentaurus Process” and “Sentaurus Interconnect.” The output of the stress and strain profiler 424 includes a representation of the three-dimensional model 428, with a mesh of nodes imposed thereon. Each node includes various detailed information about the volumetric region immediately surrounding the node, including stress and strain.

The equilibrium stress and strain determiner 430 receives the three-dimensional model with the stress and strain profile 428 and solves equilibrium stress equations globally to determine an equilibrium stress and strain state. In some embodiments, a general closed-form solution for elastic deformation of structures due to residual stresses and external bending is derived and based on the general solution, simplified solutions for residual stress and strain distributions are obtained (C.-H. Hsueh, Journal of Applied Physics, 91(12):9652-9656, 2002), incorporated by reference herein. The output of the equilibrium and strain determiner 430 is a three-dimensional model with the final stress and strain profile 432. Note that some embodiments can be designed such that the oxide has intrinsic stress; this, too, is included in the final stress and strain profile 432.

The deformation analyzer 434 uses the three-dimensional model with the final stress and strain profile 432 to determine deformation and bending for the high aspect ratio structures in the three-dimensional model and stores the results in database 436. The deformation analyzer 434 analyzes many (typically all) possible deformation modes for a target structure under many (typically all) possible combinations of process conditions. In one embodiment, the deformation analyzer 434 reports its analysis results to a user 438, either numerically or by drawing simulation images. In other embodiments, the deformation analyzer 434 uses the results of these analyses to determine the global minimum, maximum, and/or average amounts by which high aspect ratio structures have bent, and/or various other statistics regarding the possible deformations, and writes there to database 436 or reports them to a user.

The deformation analyzer 434 may further test more sets of oxidizing conditions (block 440). The set of oxidizing conditions in database 442 is revised if more sets of oxidizing conditions are to be tested.

Referring to FIG. 4, the sequence of operation of the oxidizing surface identifier 406, the one-dimensional oxidation simulator 412, the surface material etcher 416, the oxide material depositor 420, the stress and strain profiler 424, the equilibrium stress and strain determiner 430, the deformation analyzer 434, deciding whether to test more sets of oxidizing conditions 440, and even reporting to user 438 can be controlled automatically by a controller 402. Controller 402 may be a module that executes scripts to call each of the individual processing modules in the sequence set forth in FIG. 4, and defines the data flows among them. Controller 402 may be implemented, for example, with Sentaurus Workbench, available from Synopsys, Inc.

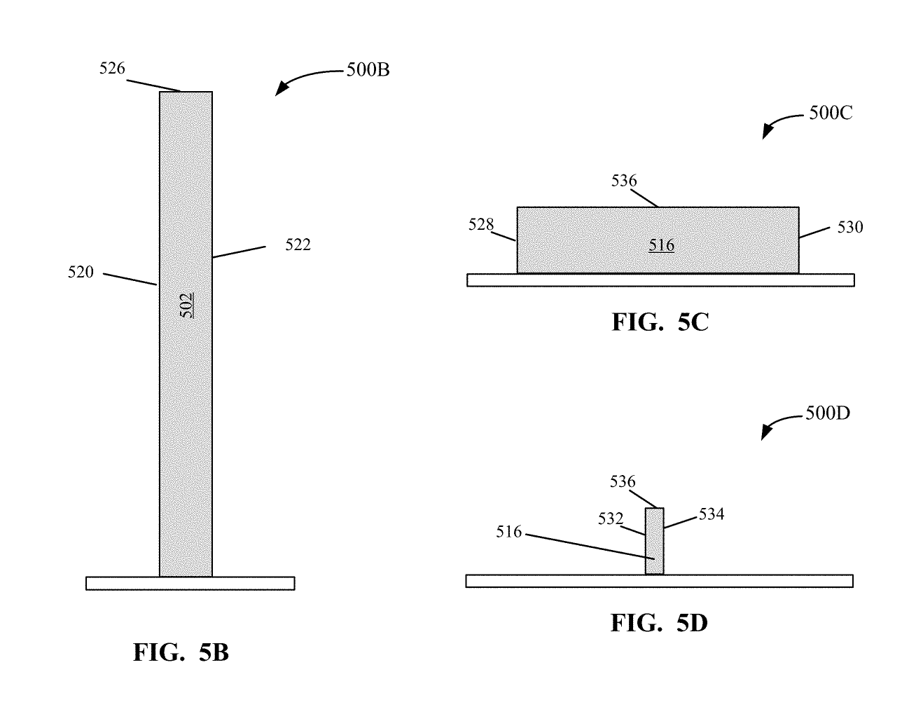

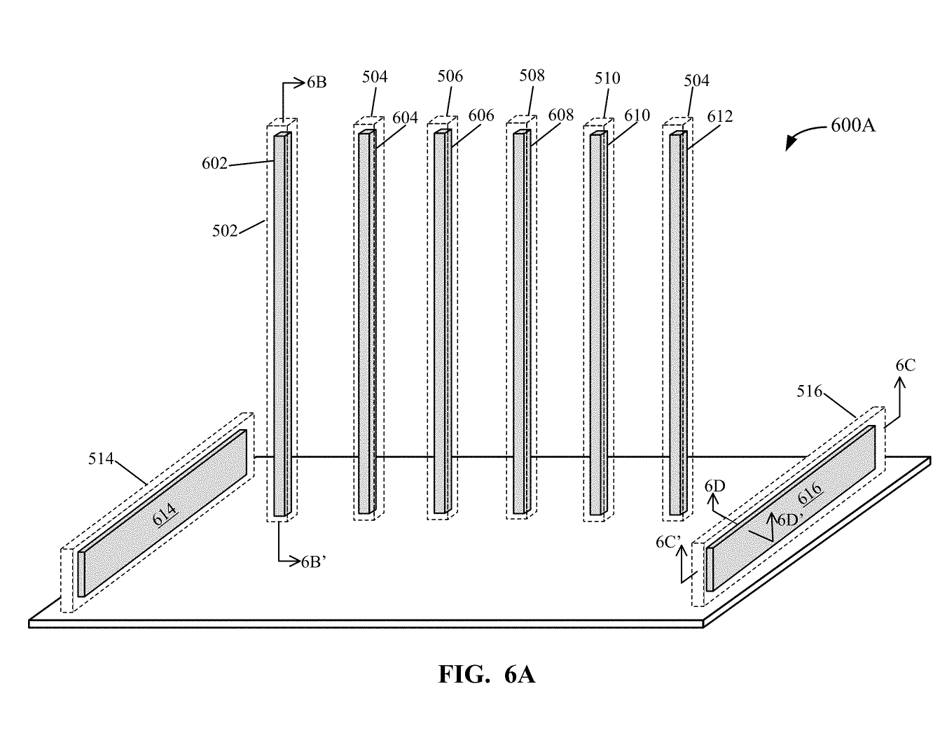

Some aspects of the invention are described herein with the aid of an example three-dimensional model 500A as collectively illustrated in FIGS. 5A, 5B, 5C and 5D in their pre-oxidation state. The three-dimensional model 500A of FIG. 5A comprises six identical pillars 502, 504, 506, 508, 510 and 512 with rectangular cross-sections, and two identical fins 514 and 518 with rectangular cross-sections. Each of the pillars and fins is classified herein to constitute a “structure”. The pillars and fins are fabricated with the same surface material. In the three-dimensional model described herein, the pillars 502, 504, 506, 508, 510 and 512, and fins 514 and 516 are also assumed to be crystalline solids. For pillar 502, surfaces 518, 520, 522, 524 and 526 are exposed to the surrounding environment. The vertical surfaces 518 and 520 have a first surface orientation, the vertical surfaces 522 and 524 have a second surface orientation, and the horizontal surface 526 has a third surface orientation. FIG. 5B illustrates a cross-sectional view 500B of the pillar 502 in FIG. 5A through lines 5B-5B′ with the vertical surfaces 520 and 522, and the horizontal surface 526. As the pillars are identical, pillars 504, 506, 508, 510, and 512 will also have the first, second and third surface orientations.

Referring to FIG. 5A, fin 516 has surfaces 528, 530, 532, 534 and 536 exposed to the surrounding environment. The vertical surfaces 528 and 530 have a fourth surface orientation, the vertical surfaces 532 and 534 have a fifth surface orientation, and the horizontal surface 536 has a sixth surface orientation. FIG. 5C illustrates a cross-sectional view 500C of the fin 516 in FIG. 5A through lines 5C-5C′ with the vertical surfaces 528 and 530, and the horizontal surface 536. FIG. 5D illustrates a cross-sectional view 500D of the fin 516 in FIG. 5A through lines 5D-5D′ with the vertical surfaces 532 and 534, and the horizontal surface 536. As fins 514 and 516 are identical, fin 516 will also have the fourth, fifth and sixth surface orientations.

The oxidizing surface identifier 406 in FIG. 4 identifies all the available exposed oxidizing surfaces in the three-dimensional model 500A in FIG. 5A that have first, second, third, fourth, fifth, or sixth surface orientation. As the pillars and the fins have the same surface materials, the oxidizing surface identifier 406 does not further classify the list of oxidizing surfaces by surface material. The oxidizing surface identifier 406 sends a list of identified oxidizing surface, (first, second, third, fourth, fifth, and sixth surface orientations with the same surface material) to one-dimensional oxidation simulator 412.

The oxidation simulator 412, along with a set of oxidizing conditions, determines the first depth of surface material oxidized during the oxidation process for surfaces with first, second, third, fourth, fifth, and sixth surface orientations.

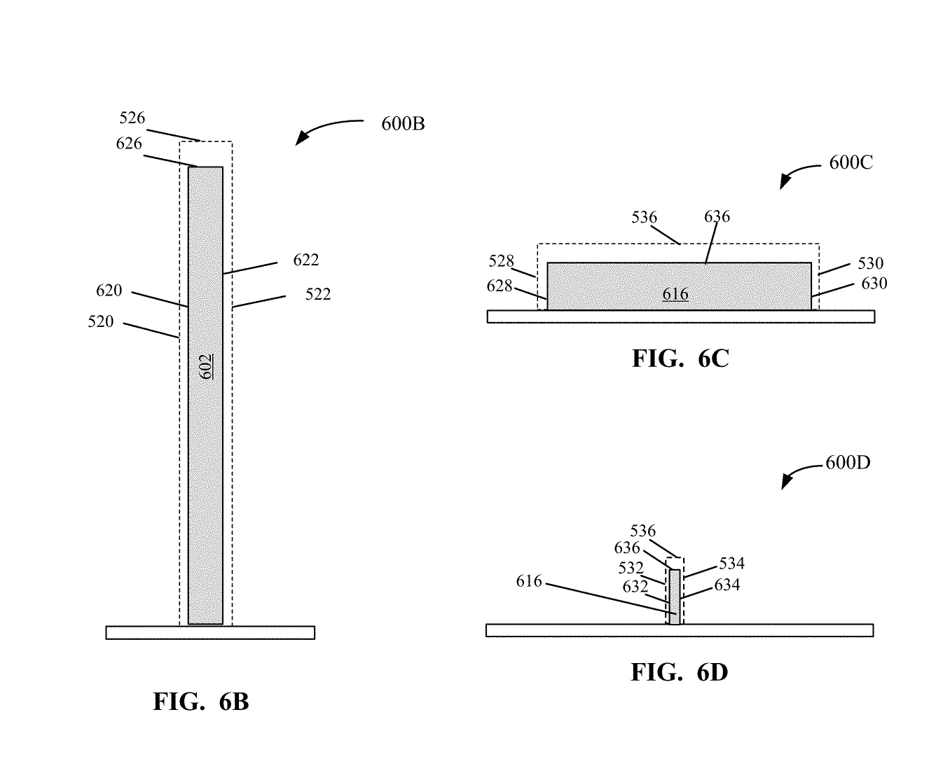

The surface material etcher 416 receives first depths of surface material oxidized for each of the identified surfaces from the one-dimensional oxidation simulator along with a three-dimensional model 500A with available oxidizing surface identified from the oxidizing surface identifier 406. For the target three-dimensional model, the surface material consumption due to oxidation is modeled by selective surface material etching. During the surface material etching modeling, surface material is selectively removed from the surfaces of the pillars 502, 504, 506, 508, 510 and 512, and the fins 514 and 516 by the first depths. In the simulation, this can be accomplished using a simple geometric operation, for example by essentially replacing the surface material in the “etched” region by a gas or vacuum region. FIG. 6 (including FIGS. 6A, 6B, 6C and 6D collectively) illustrates the three-dimensional model 600A after selective surface material etching of the three-dimensional model 500A in FIG. 5A by the surface material etcher 416. The three-dimensional model has etched pillars 602, 604, 606, 608, 610, and 612, and fins 614 and 616. Dashed lines in FIG. 6A represents the outline of the pillars 502, 504, 506, 508, 510 and 512, and fins 514 and 516 before selective etching. The volume between the dashed lines and the etched high aspect ratio structures are filled with gas or vacuum regions. FIG. 6B illustrates a cross-sectional view 600B of the etched pillar 602 in FIG. 6A through lines 6B-6B′ with the vertical etched surfaces 620 and 622, and the horizontal etched surface 626. Dashed lines 520, 522 and 526 represent the outline of the original pillar before the etching process. The first depth etched at the vertical surfaces is different than the first depth etched at the horizontal surface, as the vertical surfaces have a first surface orientation and the horizontal surface has a second surface orientation. FIG. 6C illustrates a cross-sectional view 600C of the etched fin 616 in FIG. 5A through lines 6C-6C′ with the vertical etched surfaces 628 and 630, and the horizontal etched surface 636. Dashed lines 528, 530 and 536 represent the outline of the original fin before the etching process. The first depth etched at the vertical surfaces is different than the first depth etched as the horizontal surface, as the vertical surfaces have a fourth surface orientation and the horizontal surface has a sixth surface orientation. FIG. 6D illustrates a cross-sectional view 600D of the etched fin 616 in FIG. 6A through lines 6D-6D′ with the vertical surfaces 632 and 634, and the horizontal surface 636. Dashed lines 532, 534 and 536 represent the outline of the original fin before the etching process. The first depth etched at the vertical surfaces is different than the first depth etched as the horizontal surface, as the vertical surfaces have a fifth surface orientation and the horizontal surface has a sixth surface orientation relative to the crystalline facets.

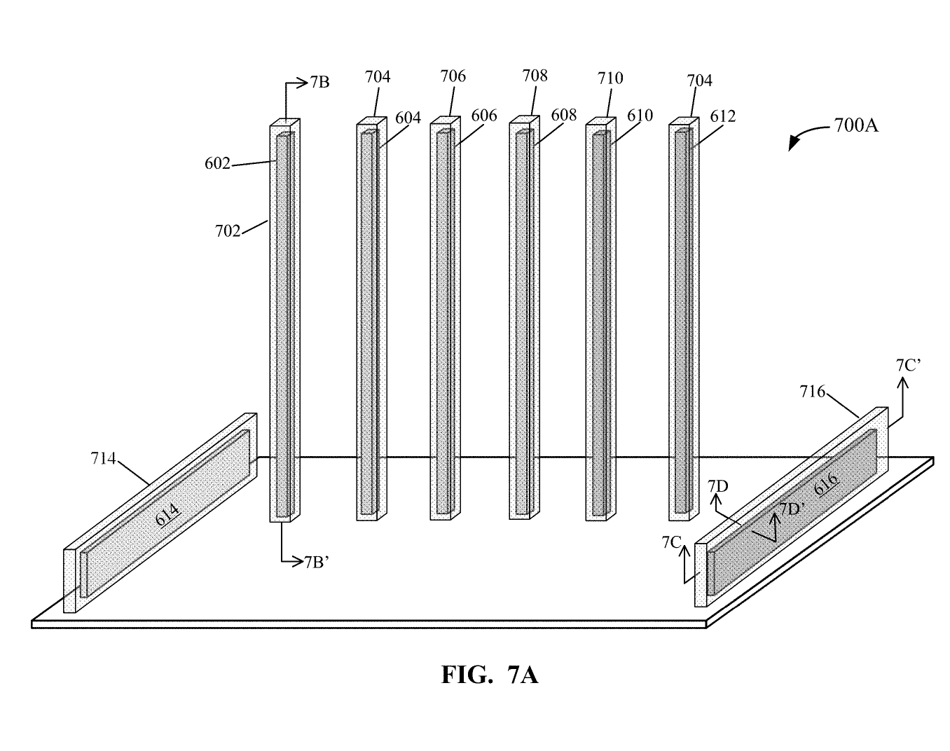

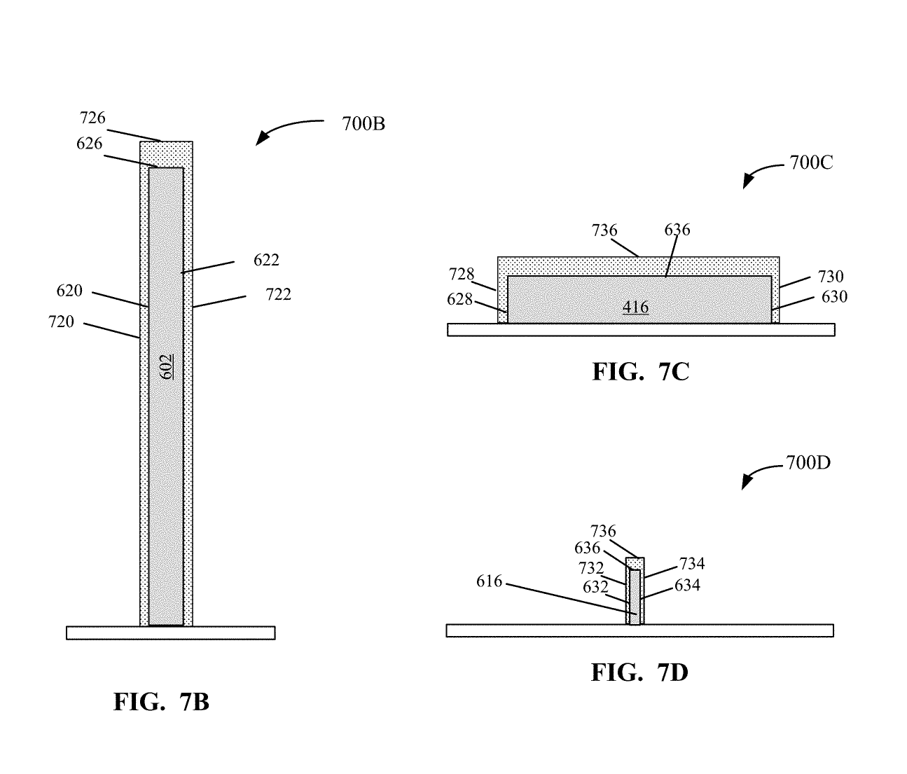

After selective etching by the surface material etcher 416, the oxide material depositor 420 fills the vacuum or gas region with the oxide material. FIG. 7 (including FIGS. 7A, 7B, 7C and 7D collectively) illustrates a three-dimensional model in FIG. 6 after selective oxide deposition by the oxide material depositor in FIG. 4. The three-dimensional model has oxide deposited pillars 702, 704, 706, 708, and 712, and fins 714 and 716. FIG. 7B illustrates a cross-sectional view 700B of the oxide deposited pillar 702 in FIG. 7A through lines 7B-7B′ with the vertical oxide deposited surfaces 720 and 722, and the horizontal oxide deposited surface 726. FIG. 7C illustrates a cross-sectional view 700C of the oxide deposited fin 716 in FIG. 7A through lines 7C-7C′ with the vertical oxide deposited surfaces 728 and 730, and the horizontal oxide deposited surface 736. FIG. 7D illustrates a cross-sectional view 700D of the oxide deposited fin 716 in FIG. 7A through lines 7D-7D′ with the vertical surfaces 732 and 734, and the horizontal surface 736.

Compressive strain and stress profiles are assigned to the three-dimensional model 700A due to surface oxidation by the stress and strain profiler 424. For example, in one embodiment with silicon pillars and fins, the initial strain field is computed from the oxide volume reduction arising from having compressed the oxide into the original volume of consumed silicon, for example based on an assumption of the new oxide undergoing ˜1.2 times volume expansion during the oxidation process. The initial stress field is computed from the strain field using a known elasticity formulation. These stresses are not yet in equilibrium, so next, the stress and strain fields are balanced globally by the equilibrium stress and strain determiner 430 to achieve an equilibrium stress and strain state in the entire three-dimensional model 700A.

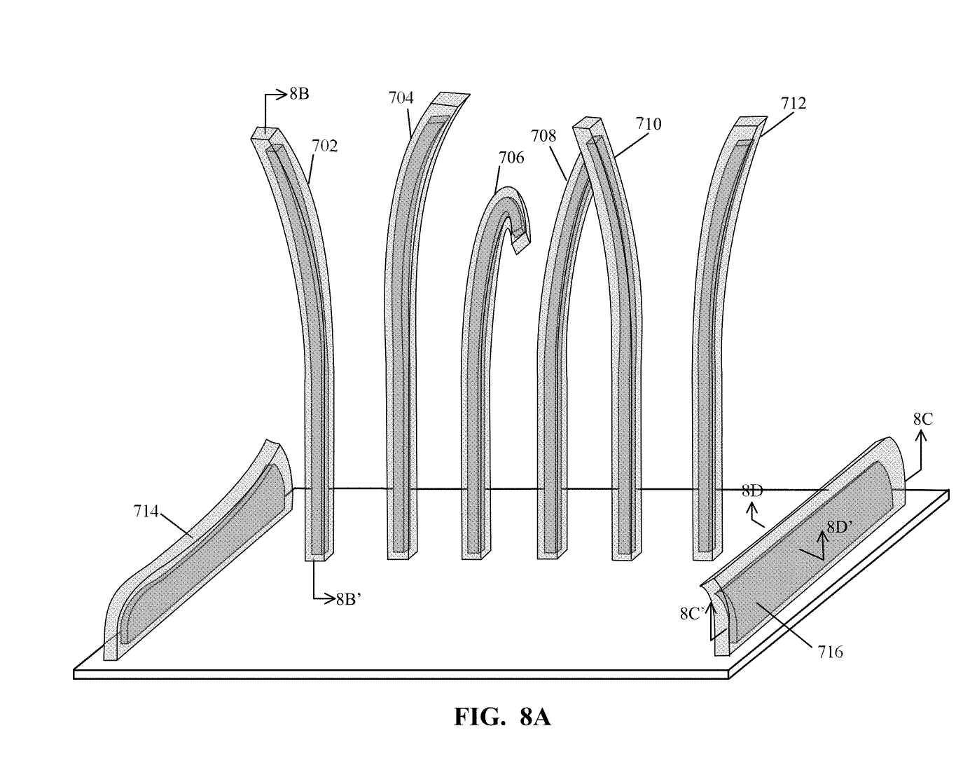

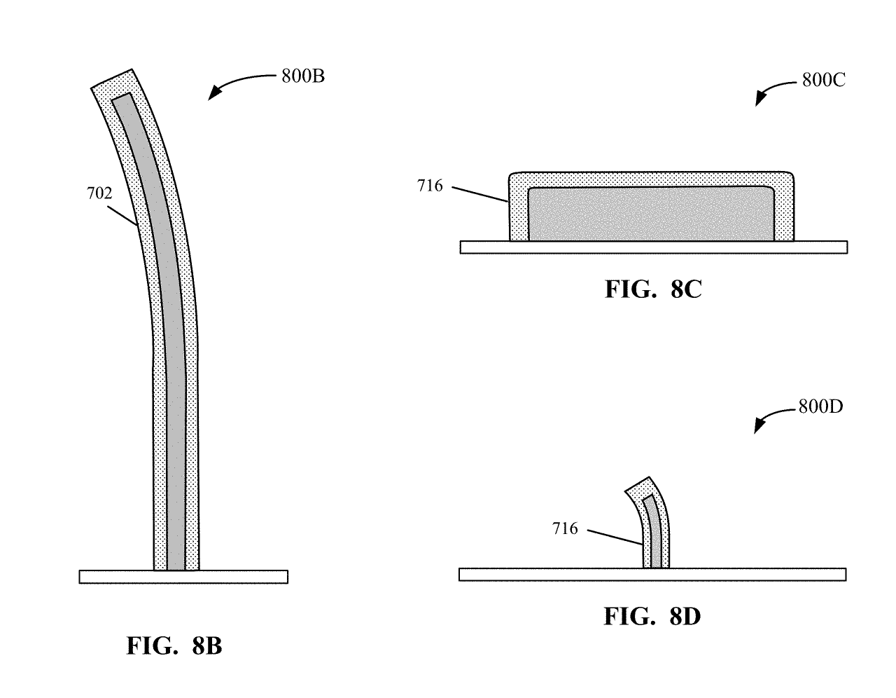

The deformation analyzer 434 uses the three-dimensional model with the final stress and strain profile to determine deformation and bending oxide deposited pillars 702, 704, 706, 708, 710 and 712, and oxide deposited fins 714 and 716. FIG. 8 (including FIGS. 8A, 8B, 8C and 8D) collectively illustrates a three-dimensional model 800A with deformation predicted by the deformation analyzer in FIG. 4. The three-dimensional model has the deformed pillars 702, 704, 706, 708, and 712, and fins 714 and 716. FIG. 8B illustrates a cross-sectional view 800B of the deformed pillar 702 in FIG. 8A through lines 8B-8B′. FIG. 8C illustrates a cross-sectional view 800C of the deformed fin 716 in FIG. 8A through lines 8C-8C′. FIG. 8D illustrates a cross-sectional view 800D of the deformed fin 716 in FIG. 8A through lines 8D-8D′.

Using the method and system described above, large scale three-dimensional high aspect ratio structures bending due to oxidation can then be analyzed in a three-dimensional model for pattern design optimization and manufacturability improvement. For example, a process engineer or computer system may try a wide variety of high aspect ratio structure patterns and spacing between the structures, or other structural or process modifications, evaluating each one with the method described above, in order to better understand the parameters for improved yield or find the combination of improvements which produces the least deformation and the best yield.

### Hardware Implementation

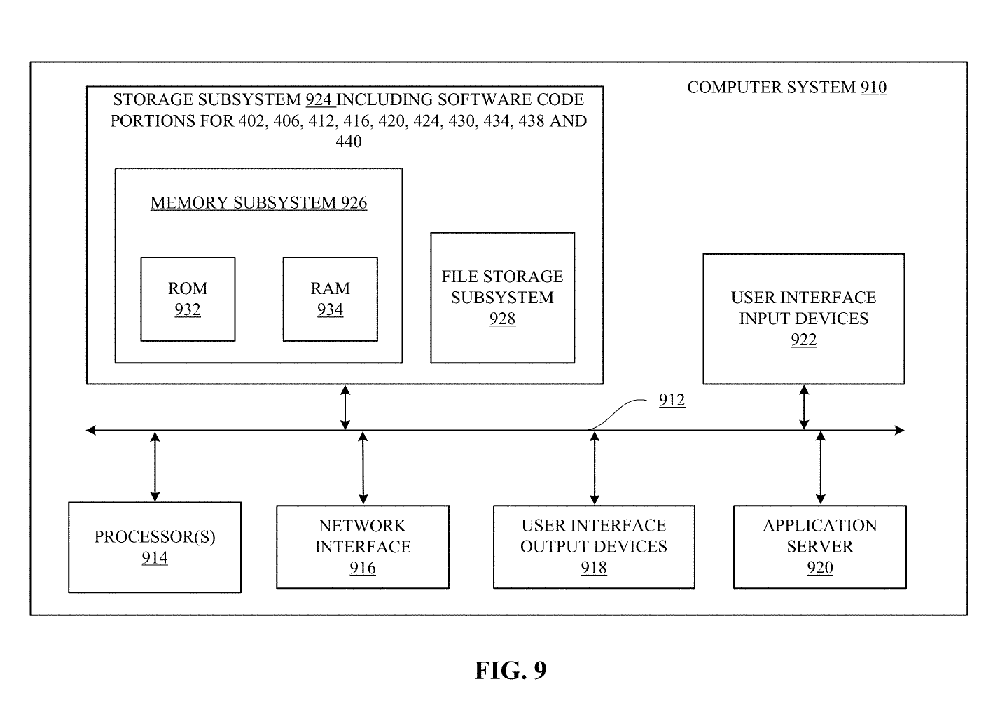

FIG. 9 is a simplified block diagram of a computer system 910 that can be used to implement any of the methods herein. Particularly it can be used to implement modules 402, 406, 412, 416, 420, 424, 430, 434, 438 and/or 440 in various embodiments. It also includes or accesses the databases 404, 408, 410, 414, 418, 422, 426, 428, 432, 436 and/or 442.

Computer system 910 typically includes a processor subsystem 914 which communicates with a number of peripheral devices via bus subsystem 912. These peripheral devices may include a storage subsystem 924, comprising a memory subsystem 926 and a file storage subsystem 928, user interface input devices 922, user interface output devices 920, and a network interface subsystem 916. The input and output devices allow user interaction with computer system 910. Network interface subsystem 916 provides an interface to outside networks, including an interface to communication network 918, and is coupled via communication network 918 to corresponding interface devices in other computer systems. Communication network 918 may comprise many interconnected computer systems and communication links. These communication links may be wireline links, optical links, wireless links, or any other mechanisms for communication of information, but typically it is an IP-based communication network. While in one embodiment, communication network 918 is the Internet, in other embodiments, communication network 918 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 922 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 910 or onto computer network 918.

User interface output devices 920 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. The display subsystem may also provide non visual display such as via audio output devices. In general, use of the term “output device” is intended to include all possible types of devices and ways to output information from computer system 910 to the user or to another machine or computer system. In one implementation, reporting by the reporting module 230 (FIG. 2) can be performed by way of the user interface output devices 920.

Storage subsystem 924 stores the basic programming and data constructs that provide the functionality of certain embodiments of the present invention. For example, the various modules implementing the functionality of certain embodiments of the invention may be stored in storage subsystem 924. These software modules are generally executed by processor subsystem 914. The databases 404, 408, 410, 414, 418, 422, 426, 428, 432, 436 and 442 may reside in storage subsystem 924.

Memory subsystem 926 typically includes a number of memories including a main random access memory (RAM) 934 for storage of instructions and data during program execution and a read only memory (ROM) 932 in which fixed instructions are stored. File storage subsystem 928 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 928. The host memory 926 contains, among other things, computer instructions which, when executed by the processor subsystem 914, cause the computer system to operate or perform functions as described herein. As used herein, processes and software that are said to run in or on “the host” or “the computer”, execute on the processor subsystem 914 in response to computer instructions and data in the host memory subsystem 926 including any other local or remote storage for such instructions and data.

Bus subsystem 912 provides a mechanism for letting the various components and subsystems of computer system 910 communicate with each other as intended. Although bus subsystem 912 is shown schematically as a single bus, alternative embodiments of the bus subsystem may use multiple busses.

Computer system 910 itself can be of varying types including a personal computer, a portable computer, a workstation, a computer terminal, a network computer, a television, a mainframe, a server farm, or any other data processing system or user device. Due to the ever changing nature of computers and networks, the description of computer system 910 depicted in FIG. 9 is intended only as a specific example for purposes of illustrating the preferred embodiments of the present invention. Many other configurations of computer system 910 are possible having more or less components than the computer system depicted in FIG. 9.

In addition, while the present invention has been described in the context of a fully functioning data processing system, those of ordinary skill in the art will appreciate that the processes herein are capable of being distributed in the form of a computer readable medium of instructions and data and that the invention applies equally regardless of the particular type of signal bearing media actually used to carry out the distribution. As used herein, a computer readable medium is one on which information can be stored and read by a computer system. Examples include a floppy disk, a hard disk drive, a RAM, a CD, a DVD, flash memory, a USB drive, and so on. The computer readable medium may store information in coded formats that are decoded for actual use in a particular data processing system. A single computer readable medium, as the term is used herein, may also include more than one physical item, such as a plurality of CD ROMs or a plurality of segments of RAM, or a combination of several different kinds of media. As used herein, the term does not include mere time varying signals in which the information is encoded in the way the signal varies over time.

As used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “indicate” is used herein to mean the same as “identify”.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the background section of this patent application are specifically incorporated by reference into the description herein of embodiments of the invention. In addition, any and all variations described, suggested or incorporated by reference herein with respect to any one embodiment are also to be considered taught with respect to all other embodiments. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method for developing an integrated circuit fabrication process, the process including an oxidation process which introduces stresses that cause deformation of structures in an integrated circuit device to be fabricated, the device including one or more three dimensional structures having starting surfaces and a starting surface material, wherein the oxidation process converts a portion of the starting surface material into an oxide material, the method comprising:
providing, accessibly to a computer system, a database describing a three-dimensional model of the structures prior to the oxidation process;
a computer system estimating, by simulation and in dependence upon a set of oxidizing conditions, a first depth by which the oxidation process converts the starting surface material to the oxide material orthogonally to the starting surface at each respective one of a plurality of surface points on the starting surfaces;
a computer system replacing the starting surface material at each of the plurality of surface points in the model with the oxide material to the first depths estimated in the estimating step;
a computer system determining an initial mechanical stress and strain field in the model in dependence upon the first depths and an expansion ratio by which a given depth of surface material expands orthogonally to the starting surfaces upon application of the oxidation process;
a computer system calculating in the model an equilibrium mechanical stress and strain field in dependence upon the initial mechanical stress and strain field, the equilibrium mechanical strain field including deformations of the structures as compared to their state prior to the oxidation process;
a computer system reporting the deformations to a user; and
repeating the estimating, replacing, determining and calculating steps using a revised set of oxidizing conditions to identify a preferred set of oxidizing conditions for improved manufacturability of the integrated circuit device.

2. The method of claim 1, wherein the starting surface material is a member of the group consisting of silicon, a silicon alloy, and polysilicon.

3. The method of claim 1, wherein in the structures prior to the oxidation process, at least one of the starting surfaces includes a thin initial layer of oxide superposing the starting surface material.

4. The method of claim 1, wherein the set of oxidation conditions includes at least one member of the group consisting of: temperature during the oxidation process, atmospheric pressure during the oxidation process, diffusants, availability of diffusants, thickness of an initial oxide layer, and a time duration of the oxidation process.

5. The method of claim 1, wherein the set of oxidation conditions includes one or more diffusants which are members of the group consisting of oxygen ions, oxygen atoms, water atoms and hydroxide ions.

6. The method of claim 1, wherein the set of oxidation conditions includes a plurality of subsets of oxidation conditions applicable at different times in the oxidation process.

7. The method of claim 1, wherein estimating a first depth by which the oxidation process converts the starting surface material to the oxide material orthogonally to the starting surface at each respective one of a plurality of surface points on the starting surfaces, comprises:
identifying a particular one of the starting surfaces considered by the computer system to be smooth;
estimating the first depth at a particular point on the particular starting surface, by simulation and in dependence upon the set of oxidizing conditions; and
estimating the first depth at a plurality of additional points on the particular starting surface in dependence upon the estimated first depth at the particular point.

8. The method of claim 1, wherein estimating a first depth by which the oxidation process converts the starting surface material to the oxide material orthogonally to the starting surface at each respective one of a plurality of surface points on the starting surfaces, comprises:
estimating the first depth at first and second particular points on respectively first and second different ones of the starting surfaces, the first and second starting surfaces having first and second different surface orientation, by simulation and in dependence upon the set of oxidizing conditions; and
estimating the first depth at a third particular point on a third starting surface having a third surface orientation, in dependence upon the first depths estimated for the first and second particular points.

9. The method of claim 8, wherein estimating the first depth at the third particular point comprises performing an interpolation function in dependence upon the third surface orientation relative to at least the first and second surface orientations.

10. The method of claim 1, wherein determining an initial mechanical stress and strain field comprises:
computing strain in the oxide material in dependence upon oxide volume reduction arising from compressing the oxide material into the volume of starting surface material replaced in the step of replacing the starting surface material; and
computing stress in the oxide material in dependence upon the strain in the oxide material.

11. The method of claim 1, wherein calculating in the model an equilibrium mechanical stress and strain field based on the initial mechanical stress and strain field comprises solving a set of 3D partial differential equations.

12. The method of claim 1, wherein at least one of the structures has a vertical dimension that is significantly larger than at least one lateral dimension of the structure.

13. The method of claim 1, wherein at least one of the structures has an aspect ratio greater than 2:1.

14. A system for developing an integrated circuit fabrication process, the process including an oxidation process which introduces stresses that cause deformation of structures in an integrated circuit device to be fabricated, the device including one or more three dimensional structures having starting surfaces and a starting surface material, wherein the oxidation process converts a portion of the starting surface material into an oxide material, the system comprising:
a database describing a three-dimensional model of the structures prior to the oxidation process;
a memory;
a data processor coupled to the memory, the data processor configured to:
estimate, by simulation and in dependence upon a set of oxidizing conditions, a first depth by which the oxidation process converts the starting surface material to the oxide material orthogonally to the starting surface at each respective one of a plurality of surface points on the starting surfaces;
replace the starting surface material at each of the plurality of surface points in the model with the oxide material to the first depths estimated in the estimating step;
determine an initial mechanical stress and strain field in the model in dependence upon the first depths and an expansion ratio by which a given depth of surface material expands orthogonally to the starting surfaces upon application of the oxidation process;
calculate in the model an equilibrium mechanical stress and strain field in dependence upon the initial mechanical stress and strain field, the equilibrium mechanical strain field including deformations of the structures as compared to their state prior to the oxidation process;
report the deformations to a user; and
repeat the estimating, replacing, determining and calculating steps using a revised set of oxidizing conditions in a program to identify a preferred set of oxidizing conditions for improved manufacturability of the integrated circuit device.

15. The system of claim 14, wherein the starting surface material is a member of the group consisting of silicon, a silicon alloy, and polysilicon.

16. The system of claim 14, wherein in the structures prior to the oxidation process, at least one of the starting surfaces includes a thin initial layer of oxide superposing the starting surface material.

17. The system of claim 14, wherein the set of oxidation conditions includes at least one member of the group consisting of: temperature during the oxidation process, atmospheric pressure during the oxidation process, diffusants, availability of diffusants, thickness of an initial oxide layer, and a time duration of the oxidation process.

18. The system of claim 14, wherein the set of oxidation conditions includes one or more diffusants which are members of the group consisting of oxygen ions, oxygen atoms, water atoms and hydroxide ions.

19. The system of claim 14, wherein the set of oxidation conditions includes a plurality of subsets of oxidation conditions applicable at different times in the oxidation process.

20. The system of claim 14, wherein in estimating a first depth by which the oxidation process converts the starting surface material to the oxide material orthogonally to the starting surface at each respective one of a plurality of surface points on the starting surfaces, the system:
identifies a particular one of the starting surfaces considered by the computer system to be smooth;
estimates the first depth at a particular point on the particular starting surface, by simulation and in dependence upon the set of oxidizing conditions; and
estimates the first depth at a plurality of additional points on the particular starting surface in dependence upon the estimated first depth at the particular point.

21. The system of claim 14, wherein in estimating a first depth by which the oxidation process converts the starting surface material to the oxide material orthogonally to the starting surface at each respective one of a plurality of surface points on the starting surfaces, the system:
estimates the first depth at first and second particular points on respectively first and second different ones of the starting surfaces, the first and second starting surfaces having first and second different surface orientation, by simulation and in dependence upon the set of oxidizing conditions; and
estimates the first depth at a third particular point on a third starting surface having a third surface orientation, in dependence upon the first depths estimated for the first and second particular points.

22. The system of claim 21, wherein in estimating the first depth at the third particular point the system performs an interpolation function in dependence upon the third surface orientation relative to at least the first and second surface orientations.

23. The system of claim 14, wherein in determining an initial mechanical stress and strain field, the system:
computes strain in the oxide material in dependence upon oxide volume reduction arising from compressing the oxide material into the volume of starting surface material replaced in the step of replacing the starting surface material; and
computes stress in the oxide material in dependence upon the strain in the oxide material.

24. The system of claim 14, wherein in calculating in the model an equilibrium mechanical stress and strain field based on the initial mechanical stress and strain field, the system solves a set of 3D partial differential equations.

25. The system of claim 14, wherein at least one of the structures has a vertical dimension that is significantly larger than at least one lateral dimension of the structure.

26. The system of claim 14, wherein at least one of the structures has an aspect ratio greater than 2:1.

27. A system for aiding in the development of an integrated circuit fabrication process, in which an integrated circuit design is fabricated by simulation using a set of process conditions under test, wherein the integrated circuit undergoes an oxidation process during fabrication, comprising:
a three-dimensional model for an integrated circuit, wherein the integrated circuit includes one or more structures each having starting surface material and having a vertical dimension that is significantly larger than at least one lateral dimension of the structure;
a set of oxidation conditions under test;
an oxidation simulator;
a surface material etcher;
an oxide material depositor;
a stress and strain profiler;
an equilibrium stress and strain determiner;
a deformation analyzer; and
a flow controller which is configured to:
operate the oxidation simulator, the oxidation simulator estimating by simulation and in dependence upon the set of oxidizing conditions, a first depth by which the oxidation process converts the starting surface material to the oxide material orthogonally to the starting surface at each respective one of a plurality of surface points on the starting surfaces;
operate the surface material etcher and the oxide material depositor, the surface material etcher and the oxide material depositor replacing the starting surface material at each of the plurality of surface points in the model with the oxide material to the first depths estimated in the estimating step;
operate the stress and strain profiler, the stress and strain profiler determining an initial mechanical stress and strain field in the model in dependence upon the first depths and an expansion ratio by which a given depth of surface material expands orthogonally to the starting surfaces upon application of the oxidation process;
operate the equilibrium stress and strain determiner and the deformation analyzer, the equilibrium stress and strain determiner calculating in the model an equilibrium mechanical stress and strain field in dependence upon the initial mechanical stress and strain field, the deformation analyzer including deformations of the structures as compared to their state prior to the oxidation process;
report the deformations to a user; and
repeat the estimating, replacing, determining and calculating steps using a revised set of oxidizing conditions in a program to identify a preferred set of oxidizing conditions for improved manufacturability of the integrated circuit device.

28-39. (canceled)

40. A non-transitory computer readable storage medium impressed with computer program instructions which, when executed by a processor, implement a method comprising:
estimating, by simulation and in dependence upon a set of oxidizing conditions, a first depth by which the oxidation process converts the starting surface material to the oxide material orthogonally to the starting surface at each respective one of a plurality of surface points on the starting surfaces;
replacing the starting surface material at each of the plurality of surface points in the model with the oxide material to the first depths estimated in the estimating step;
determining an initial mechanical stress and strain field in the model in dependence upon the first depths and an expansion ratio by which a given depth of surface material expands orthogonally to the starting surfaces upon application of the oxidation process;
calculating in the model an equilibrium mechanical stress and strain field in dependence upon the initial mechanical stress and strain field, the equilibrium mechanical strain field including deformations of the structures as compared to their state prior to the oxidation process;
reporting the deformations to a user; and
repeating the estimating, replacing, determining and calculating steps using a revised set of oxidizing conditions in a program to identify a preferred set of oxidizing conditions for improved manufacturability of the integrated circuit device.

41-52. (canceled)
